(19) United States
(12) Patent Application Publication
(10) Pub. No.: US 2002/0079817 A1
(43) Pub. Date: Jun. 27, 2002

(54) Electron gun assembly and cathode ray tube

(76) Inventor: Noriyuki Miyamto, Iruma-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/024,235

(22) Filed: Dec. 21, 2001

(30) Foreign Application Priority Data
Dec. 26, 2000 (JP) 2000-394911
Nov. 22, 2001 (JP) 2001-358334

(51) Int. Cl. H01J 29/50

(52) U.S. Cl. 313/412

(57) ABSTRACT

An electron gun assembly comprises a cathode capable of emitting electron beams and at least first and second grid electrodes having electron beam holes through which the electron beams emitted from the cathode are passed individually and capable of controlling the electron beams. The first and/or second grid electrode is a superposed structure formed of different metallic materials superposed in the advancing direction of the electron beams. The grid electrode includes a Fe—Ni—Co alloy located around the electron beam holes.

### CROSS-REFERENCE TO RELATED APPLICATIONS

This application is based upon and claims the benefit of priority from the prior Japanese Patent Applications No. 2000-394911, filed Dec. 26, 2000; and No. 2001-358334, filed Nov. 22, 2001, the entire contents of both of which are incorporated herein by reference.

### BACKGROUND OF THE INVENTION

1. Field of the Invention

The present invention relates to an electron gun assembly and a cathode ray tube, and more particularly, to an electron gun assembly of which a first and/or second grid electrode is improved in press-moldability without failing to maintain specific properties and a cathode ray tube using the electron gun assembly.

2. Description of the Related Art

Color cathode ray tubes that are currently used in color TV sets, color displays, etc. are provided with an in-line electron gun assembly that emits three electron beams in a line. As shown in FIG. 8, the in-line electron gun assembly of this type, e.g., an electron gun assembly of the BPF (bi-potential-focus) type, is provided with three cathodes K and four grid electrodes G1 to G4. The first and second grid electrodes G1 and G2 are formed of a plate electrode for controlling an electron beam each. The third and fourth grid electrodes G3 and G4 are formed of cup-shaped electrodes.

The grid electrodes G1 to G4 are provided with their respective triplets of electron beam holes 81 to 86 through which three electron beams are passed individually. The grid electrodes G1 to G4 are fixedly held in position by means of a pair of insulating supports (not shown) of glass material.

In consideration of the influences of heat and magnetic fields that are generated during the operation of the cathode ray tube, for example, the grid electrodes G1 to G4 must be constructed so as to stabilize the electron gun properties. For example, heat generated from the cathodes K at the start of the operation of the cathode ray tube radiate to cause thermal expansion of the structure that constitutes the first grid electrode G1. In consequence, the spaces between the grid electrodes G1 to G4 change with the heating time of the cathodes K. Therefore, the electron beams emitted from the electron gun assembly cannot be supplied steadily. On the other hand, the respective trajectories of the electron beams emitted from the cathodes K are controlled by means of external magnetic fields of a deflection yoke mounted on the outside of the cathode ray tube or a correcting magnet for correcting purity and convergence. If the grid electrodes G1 to G4 are formed of a magnetic material, it is hard to control the electron beam trajectories by means of the external magnetic fields.

Actually, therefore, the materials for the grid electrodes G1 to G4 are based on suitable combinations of metallic materials including Fe—Ni and Fe—Ni—Co alloys, which have a low thermal expansion property, and Fe—Ni—Cr alloys, which have a nonmagnetic property. The metallic materials for the grid electrodes are formed into a given electrode shape by press operations including drawing, drilling, bulging, etc. after they are formed into a strip with a given thickness by casting, forging, hot working, cold working, etc.

Recently, there have been increasing demands in the market for large-screen, high-precision versions of color cathode ray tubes. Correspondingly, there have been urgent requests for electron gun assemblies for use as sources of generation and control of electron beams. To meet these requirements, an electron lens that is a combination of the grid electrodes G1 to G4 tends to be complicated. In consequence, the respective shapes of the grid electrodes that constitute the electron gun assembly are inclined to be complicated. In the first and second grid electrodes G1 and G2 that have relatively small electron beam holes, in particular, the shapes of the respective peripheries of their electron beam holes 81 and 82 are complicated and require high working accuracy.

In some cases, therefore, satisfactory working accuracy cannot be obtained with use of the conventional metallic materials that are selected with priority to properties such as thermal and magnetic properties. Thus, it is hard to form the grid electrodes in given shapes, depending on the shapes of the electron beam holes 81 and 82.

In general, the moldability of a metal is given by an index of the metal, called a work-hardening exponent. The work-hardening exponent varies depending on the properties and contents of elements that constitute the alloys. The lower the work-hardening exponent of the metal, the more easily the metal is believed to be molded. Since the contents of the elements are also related deeply to the chemical and physical properties, including the thermal expansion property, however, it is hard to reconcile the required properties with press-moldability. In modern cathode ray tubes, therefore, the first and second grid electrodes G1 and G2 that require complicated working are bound be formed of materials with high press-moldability.

The aforesaid various alloys are used as metallic materials that form the grid electrodes G1 to G4 of the electron gun assembly shown in FIG. 8. Among these alloys, Fe—Ni—Co alloys have the lowest work-hardening exponent, and Fe—Ni—Cr alloys and Fe—Ni alloys are the worst and second-worst in press-moldability, respectively. Actually, therefore, an Fe—Ni—Co alloy is used to form all the first and second grid electrodes G1 and G2 that involve complicated molding for the peripheries of the electron beam holes 81 and 82.

The Fe—Ni—Co alloy is poor in physical properties, such as the thermal expansion property, mechanical properties, chemical properties, etc. Therefore, the degree of freedom of design of electrodes that use the Fe—Ni—Co alloy is restricted inevitably. Further, the Fe—Ni—Co alloy contains expensive Co elements, rare metals. Accordingly, the material cost is very high if all the electrodes are formed of the Fe—Ni—Co alloy.

Thus, in the conventional electron gun assembly and color cathode ray tube, the first and second grid electrodes G1 and G2 that involve complicated molding for the peripheries of the electron beam holes, in particular, should preferably be formed of the Fe—Ni—Co alloy that enjoys high press-moldability. Since the use of the Fe—Ni—Co alloy automatically settles the physical properties, including the thermal expansion property, mechanical properties, chemical properties, etc. of the electrodes, however, the degree of freedom of design of the grid electrodes may be restricted, or the electrodes themselves may be expensive.

### BRIEF SUMMARY OF THE INVENTION

The present invention has been contrived in consideration of these circumstances, and its object is to provide an electron gun assembly and a color cathode ray tube, having electrodes that can be molded with high working accuracy without failing to maintain specific properties such as physical properties.

An electron gun assembly according to a first aspect of the invention comprises a cathode capable of emitting electron beams and at least first and second grid electrodes having electron beam holes through which the electron beams emitted from the cathode are passed individually and capable of controlling the electron beams, the first and/or second grid electrode being a superposed structure formed of different metallic materials superposed in the advancing direction of the electron beams and including a Fe—Ni—Co alloy located around the electron beam holes.

A cathode ray tube according to a second embodiment of the invention comprises a substantially rectangular face panel, a funnel connected to the face panel, an electron gun assembly located in a neck of the funnel and having a plurality of grid electrodes capable controlling electron beams, and a phosphor screen formed on the inner surface of the face panel, a first and/or second grid electrode, among other grid electrodes of the electron gun assembly, being a superposed structure formed of different metallic materials superposed in the advancing direction of the electron beams and including a Fe—Ni—Co alloy located around the electron beam holes.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cutaway perspective view schematically showing principal components of a color cathode ray tube according to an embodiment of the invention;

FIG. 2 is a horizontal sectional view schematically showing principal components of an electron gun assembly applicable to the color cathode ray tube shown in FIG. 1;

FIG. 3A is a plan view schematically showing a construction of a first grid electrode shown in FIG. 2;

FIG. 3B is a sectional view schematically showing a profile of the first grid electrode taken along line A-A′ of FIG. 3A;

FIG. 4 is a horizontal sectional view schematically showing principal components of another electron gun assembly applicable to the color cathode ray tube shown in FIG. 1;

FIG. 5A is a plan view schematically showing another construction of a grid electrode of the electron gun assembly applicable to the color cathode ray tube shown in FIG. 1;

FIG. 5B is a sectional view schematically showing a profile of the grid electrode taken along line B-B′ of FIG. 5A;

FIG. 6 is a horizontal sectional view schematically showing principal components of still another electron gun assembly applicable to the color cathode ray tube shown in FIG. 1;

FIG. 7 is a sectional view showing a conventional color cathode ray tube; and

FIG. 8 is a horizontal sectional view showing principal components of a conventional electron gun assembly.

### DETAILED DESCRIPTION OF THE INVENTION

An embodiment of the present invention will now be described in detail with reference to the accompanying drawings.

As shown in FIG. 1, a color cathode ray tube 1 comprises an envelope that includes a substantially rectangular face panel 11 and a funnel 12 bonded integrally to the face panel 11. A phosphor screen 13 is located on the inner surface of the face panel 11. The screen 13 has light absorbing layers 14 and three-color phosphor layers 15 that are embedded in gap portions between the layers 14 and glow blue, green, and red, individually. The phosphor screen 13 of the black-stripe (or black-matrix) type is constructed in this manner.

In the envelope, a shadow mask 17 having a color sorting function is opposed to the phosphor screen 13. The mask 17 has a large number of apertures through which three electron beams 16, including a center beam 16G and a pair of side beams 16B and 16R, are passed. The shadow mask 17 is fixed to a mask frame 18 that is attached to the inner surface side of the face panel 11.

An in-line electron gun assembly 20 is located in a neck 19 of the funnel 12. The electron gun assembly 20 emits three electron beams 16B, 16G and 16R that are arranged in a line in a horizontal direction X. A deflection yoke 21 is mounted on a large-diameter portion of the funnel 12 and the neck 19. The yoke 21 generates a non-uniform deflecting magnetic field that deflects the three electron beams 16B, 16G and 16R from the electron gun assembly 20 in the horizontal direction X and a vertical direction Y. The non-uniform deflecting magnetic field is formed of a horizontally deflecting magnetic field of the pincushion type, which is generated by means of a horizontally deflecting coil, and a vertically deflecting magnetic field of the barrel type, which is generated by means of a vertically deflecting coil. If necessary, a purity magnet or the like is attached to the outer periphery of the neck 19 behind the deflection yoke 21.

The three electron beams 16B, 16G and 16R emitted from the electron gun assembly 20 are self-converged as they are deflected by means of the non-uniform magnetic field that is generated by the deflection yoke 21. The phosphor screen 13 is scanned in the horizontal and vertical directions X and Y with the aid of the shadow mask 17. Thereupon, a color image is displayed on the screen 13. Thus, the convergence can be adjusted without using a dynamic convergence circuit, so that the power consumption can be reduced.

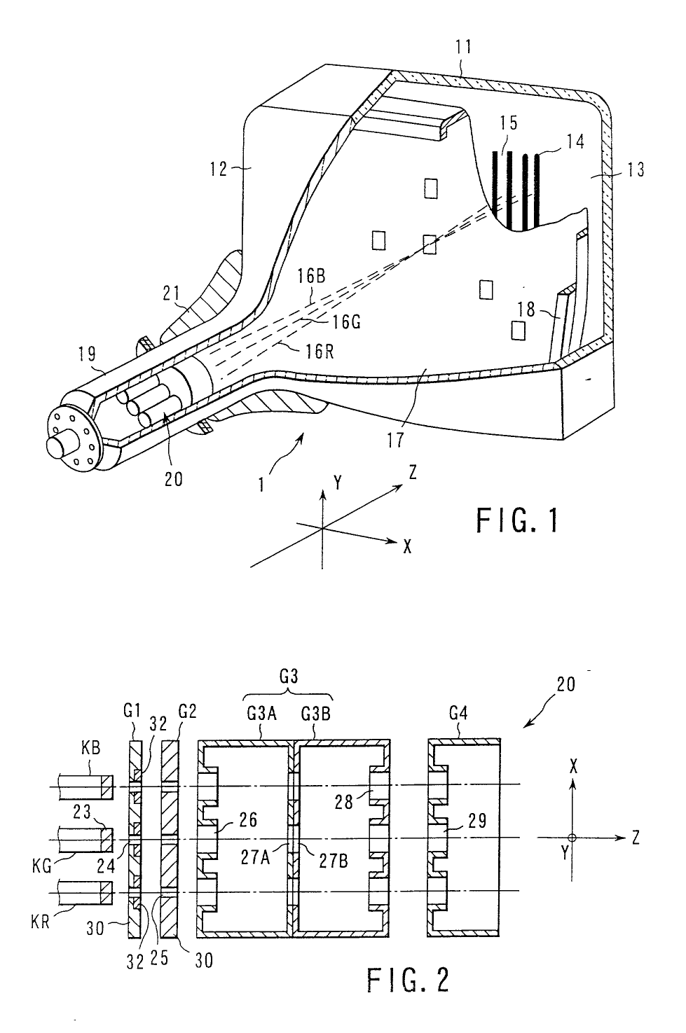

The in-line electron gun assembly 20 is of the BPF type, for example, which is constructed in the manner shown in FIG. 2. More specifically, the electron gun assembly 20 comprises three cathodes KR, KG and KB and four grid electrodes G1 to G4. The three cathodes KR, KG and KB are arranged independently in a line on the same plane. Each cathode K is provided with a cathode disc 23 that emits an electron beam. The four grid electrodes G1 to G4 are successively arranged from the cathodes K toward the phosphor screen in the advancing direction of the electron beams or direction Z.

The first grid electrode G1 is located at a given distance from the three cathodes K. The second grid electrode G2 is located at a given distance from the first grid electrode G1. The first and second grid electrodes G1 and G2 are formed of a plate electrode for controlling an electron beam each. The first grid electrode G1 has electron beam holes 24 through which the three electron beams 16R, 16G and 16B are passed individually. The second grid electrode G2 has electron beam holes 25 through which the three electron beams 16R, 16G and 16B are passed individually.

The third grid electrode G3 is located at a given distance from the second grid electrode G2. It is composed of a plurality of cup-shaped electrodes for focusing the electron beams. More specifically, a cylindrical electrode G3A of the third grid electrode G3 that is located nearer to the second grid electrode G2 is composed of two cup-shaped electrodes. The cylindrical electrode G3A has electron beam holes 26 for the passage of the three electron beams 16R, 16G and 16B in its end face that is opposed to the second grid electrode G2. Further, the electrode G3A has electron beam holes 27A for the passage of the three electron beams 16R, 16G and 16B in its end face that is located nearer to the fourth grid electrode G4. A cylindrical electrode G3B of the third grid electrode G3 that is located nearer to the fourth grid electrode G4 is composed of two cup-shaped electrodes. The cylindrical electrode G3B has electron beam holes 27B for the passage of the three electron beams 16R, 16G and 16B in its end face that is located nearer to the second grid electrode G2. Further, the electrode G3B has electron beam holes 28 for the passage of the three electron beams 16R, 16G and 16B in its end face that is opposed to the fourth grid electrode G4.

The fourth grid electrode G4 is located at a given distance from the third grid electrode G3. It is composed of a cup-shaped electrode for accelerating the electron beams. Electron beam holes 29 for the passage of the three electron beams 16R, 16G and 16B are formed in that end face of the fourth grid electrode G4 that faces the third grid electrode G3.

The grid electrodes G1 to G4 are fixedly held in position by means of a pair of insulating supports of glass material.

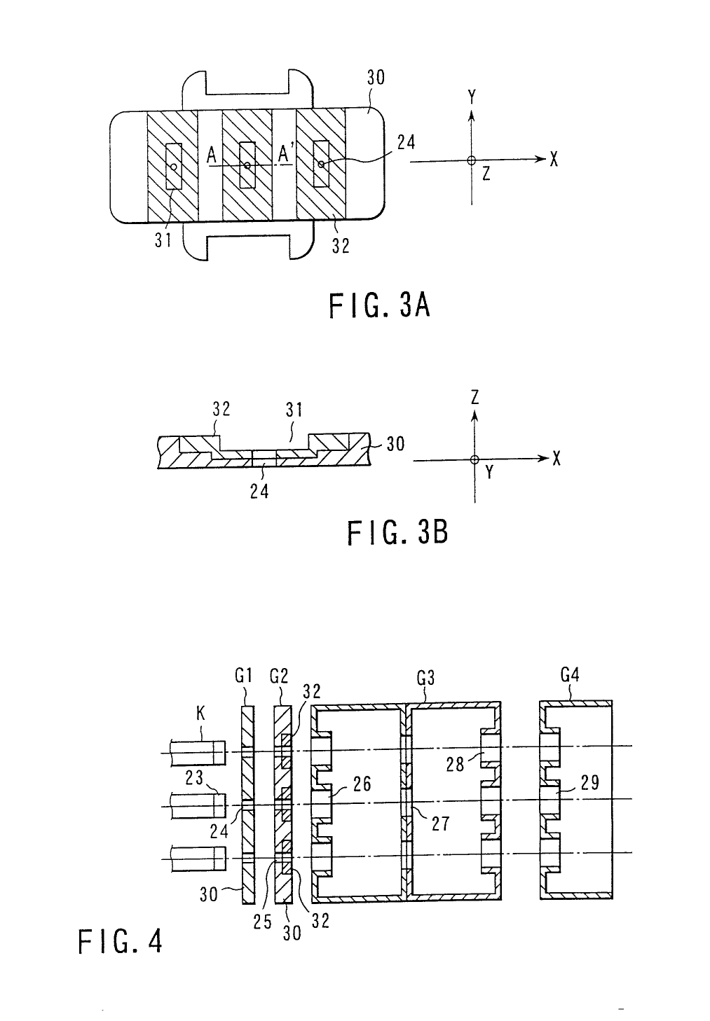

According to this embodiment, as shown in FIGS. 3A and 3B, the first grid electrode G1 is a superposed structure formed of different metallic materials that are superposed in the electron beam advancing direction Z. More specifically, the first grid electrode G1 is composed of an electrode substrate 30 and superposed electrode plates 32 that are located nearer to the second grid electrode G2 than the substrate 30 is.

The electrode substrate 30 and the superposed electrode plates 32 are provided with the three electron beam holes 24 corresponding individually to the three cathodes K that are arranged in a line. Further, the electrode substrate 30 and the superposed electrode plates 32 are provided with slits 31 in that surface which faces the second grid electrode G2, whereby electron lenses are formed. In this embodiment, each electron beam hole 24 is substantially circular, while each slit 31 has the shape of a rectangle of which the long side extends in the vertical direction Y. In other words, the electrode substrate 30 is provided with the superposed electrode plates 32 that are formed of a material different from that of the electrode substrate 30 and are superposed on the surface around the electron beam holes 24, covering the slits 31.

The electrode substrate 30, which constitutes the first grid electrode GI, is formed of, for example, an Fe—Ni alloy that contains 42% of Ni (nickel) and Fe (iron) for the remainder. The superposed electrode plates 32 are formed of at least one metallic material that is selected among Fe—Ni—Co alloys. In this embodiment, the electrode plates 32 are formed of, for example, an Fe—Ni—Co alloy called Kovar that contains, for example, 29% of Ni, 17% of Co (cobalt), and Fe for the remainder.

Each superposed electrode plate 32 is located in a region around each electron beam hole 24 that is 15 to 650 times as wide as the area of each beam hole 24. If the diameter and area of each electron beam hole 24 are adjusted to 0.62 mm and about 0.97 mm², respectively, according to this embodiment, each superposed electrode plate 32 is located in a region that is 4.00 mm long in the horizontal direction X and 13.50 mm long in the vertical direction Y (region about 56 times as wide as the area of each electron beam hole).

Further, each superposed electrode plate 32 has a thickness that is equal to 40% or more of the thickness of the whole superposed structure that constitutes the first grid electrode G1. If the thickness of the whole superposed structure is, for example, 0.25 mm, according to this embodiment, the thickness of each superposed electrode plate 32 is adjusted to 0.125 mm that is equivalent to 50% of the thickness of the whole structure. Each superposed electrode plate 32 is located in a region around each corresponding electron beam hole 24, covering each corresponding slit 31. In this case, the whole first grid electrode G1 that includes the peripheral portion around the electron beam holes 24 maintains its given thickness.

The electrode substrate 30 and the superposed electrode plates 32 that constitute the first grid electrode G1 are contact-bonded to one another by, for example, the inlay-cladding method in which different metals are partially joined together, among other conventional cladding methods for contact bonding that are based on mechanical rolling and used to form claddings.

Thus, a metallic material that has outstanding specific properties, including physical properties such as the thermal expansion property, mechanical properties, chemical properties, etc., is preferentially used for the electrode substrate 30, despite its originally poor moldability. Further, the superposed electrode plates 32 are located only in those regions that are to be subjected to complicated molding, e.g., the regions around the electron beam holes 24, and a high-moldability metallic material is selectively used to form the superposed electrode plates 32. The electron beam holes 24 are formed by press-molding those portions in which the superposed electrode plates 32 are arranged. Thus, the electrodes that require high-accuracy complicated molding can be formed without failing to maintain the specific properties with priority.

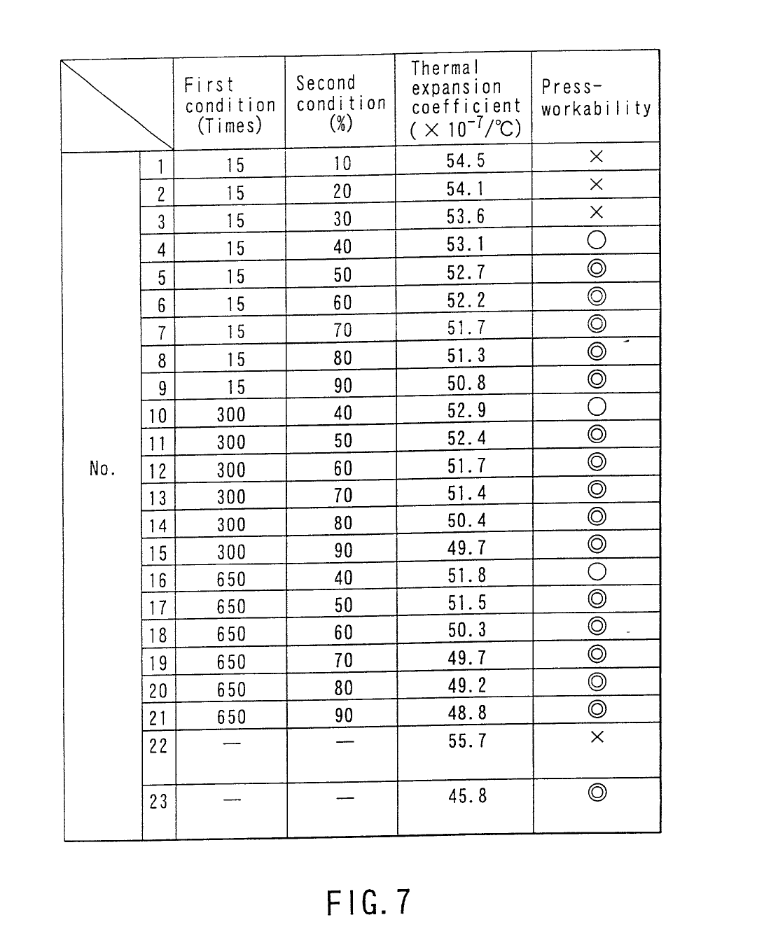

Conditions for the arrangement of the superposed electrode plates 32 of the first grid electrode G1 constructed in this manner were changed variously, and measurements were made on the thermal expansion coefficient and the press-workability for complicated shapes (e.g., working accuracy for the electron beam holes with small diameters). FIG. 7 shows the results of the measurements. In FIG. 7, the thermal expansion coefficient is given by measured values obtained at temperatures of 30° C. to 300° C. For the press-workability, crosses (X), circles (◯), and double circles (⊚) represent materials that cannot be worked with ease, materials that enjoy good workability, and materials that enjoy very good workability, respectively.

In measurement items Nos. 1 to 21, the metallic material that constitutes the electrode substrate 30 is an Fe—Ni alloy that contains 42% of Ni and Fe for the remainder. Further, the metallic material that constitutes the superposed electrode plates 32 is an Fe—Ni—Co alloy (Kovar) that contains 29% of Ni, 17% of Co, and Fe for the remainder. Thus, the first grid electrode G1 is formed by press-molding the electrode substrate 30 and the superposed electrode plates 32 that are superposed on one another. In measurement item No. 22, the whole first grid electrode G1 is formed by press-molding a structure of the Fe—Ni alloy that contains 42% of Ni and Fe for the remainder. In measurement item No. 23, the whole electrode is composed of Kovar, and the first grid electrode G1 is formed by press molding.

The arrangement conditions to be varied include the ratio of the area of each superposed electrode plate 32 to the area of each electron beam hole, as a first condition, and the ratio of the thickness of each superposed electrode plate 32 to that of the whole grid electrode, as a second condition. In measurement items Nos. 1 to 9, the first condition is adjusted to 1,500% (15 times), and the second condition to 10% to 90%. In measurement items Nos. 10 to 15, the first condition is adjusted to 30,000% (300 times), and the second condition to 40% to 90%. In measurement items Nos. 16 to 21, the first condition is adjusted to 65,000% (650 times), and the second condition to 40% to 90%.

As shown in FIG. 7, the thermal expansion coefficient of the grid electrode varies depending on the arrangement conditions for the superposed electrode plates 32, that is, the first and second conditions. It was found that good press-workability can be obtained when the conditions are applicable to measurement items Nos. 4 to 21. Thus, it is to be desired that the first condition, i.e., the ratio of the area of each superposed electrode plate 32 to the area of each electron beam hole, out of the arrangement conditions for the superposed electrode plates 32, should be 1,500% or more, and the second condition, i.e., the ratio of the thickness of each superposed electrode plate 32 to that of the whole electrode, be 40% or more.

If the first condition exceeds 65,000%, however, the difference in the thermal expansion coefficient between the electrode substrate 30 and the superposed electrode plates 32 increases. It was found, therefore, that a bimetal effect is inevitably produced to cause deformation of the electrode itself as the temperature increases. Thus, it is to be desired that the first condition should be adjusted to 65,000% or less. High press-moldability can be obtained without failing to maintain the specific properties by arranging the superposed electrode plates 32 on the electrode substrate 30 under the first condition.

If the ratio of the thickness of each superposed electrode plate 32, as the second condition, is low, that is, if each plate 32 is thin, the press-workability is poor. In order to obtain good press-workability, therefore, the second condition should be adjusted to at least 40% or more, preferably to 50% or more.

It was found, moreover, that the thermal expansion property and the press-workability cannot be easily reconciled with each other when the electrode is formed of the electrode substrate 30 alone without using the superposed electrode plates 32. If the electrode substrate 30 is formed of the Fe—Ni alloy only, as in the case of measurement item No. 22, for example, its press-workability is poor, though its thermal expansion property is excellent. If the electrode substrate 30 is formed of Kovar only, as in the case of measurement item No. 23, on the other hand, its thermal expansion property is poor, though its press-workability is excellent.

According to this embodiment, as described above, the first grid electrode G1 is a superposed structure formed of different metallic materials that are superposed in the electron beam advancing direction. This grid electrode G1, in particular, is provided with the superposed electrode plates 32 of the Fe—Ni—Co alloy that are arranged around the electron beam holes 24. Each superposed electrode plate 32 is located in a region around each electron beam hole 24 that is 15 to 650 times as wide as the area of each beam hole 24. Further, each superposed electrode plate 32 is superposed with a thickness equal to 40% to less than 100% of the thickness of the whole electrode.

Thus, the grid electrode is formed of a first metallic material that is selected with priority to the required specific properties including the physical, mechanical, and chemical properties and a second metallic material that is selected with priority to the working accuracy. More specifically, the electrode substrate is formed of a metallic material (e.g., Fe—Ni alloy) that is excellent in specific properties such as the thermal expansion property. Further, a metallic material (e.g., Fe—Ni—Co alloy) with excellent moldability is superposed on the electrode substrate and pressed on those regions including the electron beam holes which require complicated molding. By doing this, high press-moldability can be obtained without failing to fulfilling the necessary specific properties. In consequence, various required properties of the color cathode ray tube, such as the thermal properties and flying properties, can be improved.

The Fe—Ni alloy is used as the material of the electrode substrate 30 described above. However, the same measurement made for the case where a Fe—Ni—Cr alloy was used in place of the Fe—Ni alloy revealed the same tendency. Thus, the electrode substrate 30 and the superposed electrode plates 32 of the grid electrode may be formed of the Fe—Ni—Cr and Fe—Ni—Co alloys, respectively.

The present invention is not limited to the embodiment described above, and various changes and modifications may be effected therein. In the foregoing embodiment, for example, the first grid electrode G1 is composed of a superposed structure. Alternatively, however, the second grid electrode G2 may be composed of a superposed structure. If the second grid electrode G2 requires high press-moldability without failing to fulfilling the necessary specific properties, it may be formed by superposing different metallic materials in the electron beam advancing direction, as shown in FIG. 4.

More specifically, the second grid electrode G2 is composed of an electrode substrate 30 and superposed electrode plates 32 that are located nearer to a third grid electrode G3 than the substrate 30 is. In this case, the electrode substrate 30 is formed of a metallic material such as an Fe—Ni alloy that is selected with priority to the working accuracy. The superposed electrode plates 32 are arranged mainly in regions that require high working accuracy, such as regions corresponding to electron beam holes and their peripheral portions, so as to meet the aforesaid arrangement conditions (first and second conditions). Thus, the same effect of the foregoing embodiment can be obtained.

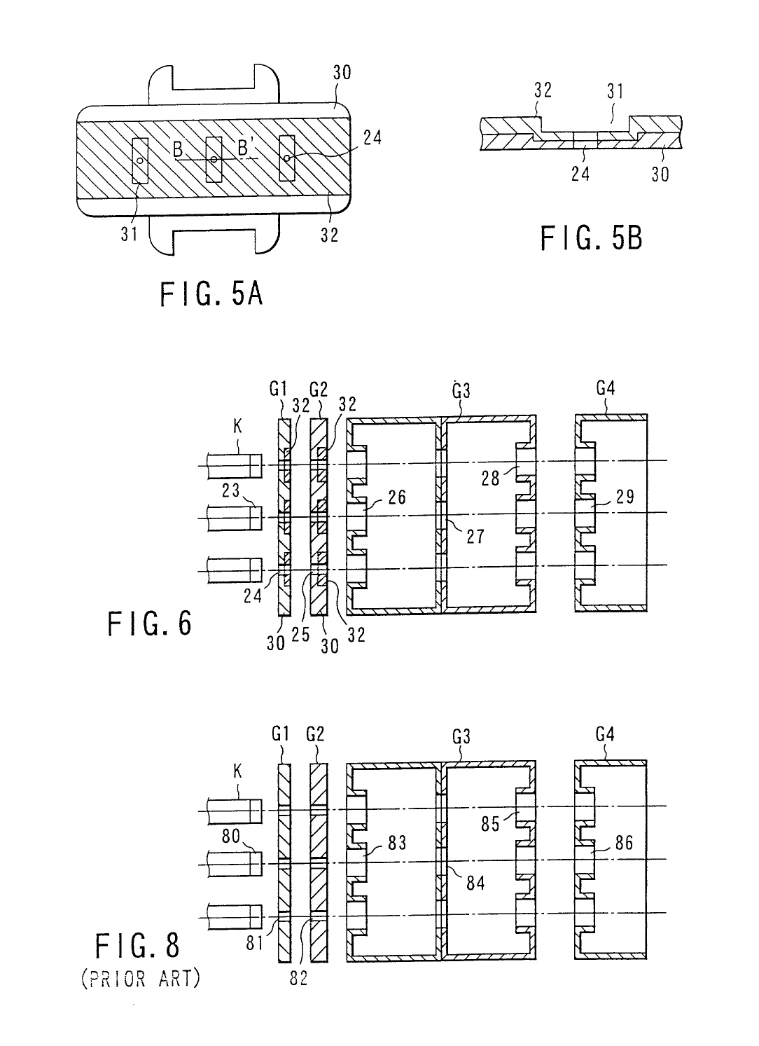

For grid electrodes (e.g., first and second grid electrodes) having complicated shapes that require high working accuracy, a superposed electrode plate 32 may be formed integrally covering three electron beam holes 24, as shown in FIGS. 5A and 5B.

As shown in FIG. 6, moreover, either of first and second grid electrodes G1 and G2 may be composed of a superposed structure that includes an electrode substrate 30 and superposed electrode plates 32 superposed on one another.

Further, a grid electrode may be composed of a three-layer superposed structure in which superposed electrode plates 32 are arranged on the opposite surfaces of an electrode substrate 30 so that the substrate 30 is sandwiched between the plates 32. In the case described above, furthermore, the electron gun assembly of the color cathode ray tube is of the bi-potential type. It is to be understood, however, that the present invention may be also applied to various electron gun assemblies, such as a unipotential electron gun assembly, a composite electron gun assembly that combines the bi-potential and unipotential type, and a high-unipotential electron gun assembly, or an electron gun assembly of a black-and-white cathode ray tube, and that various changes and modifications may be effected therein.

According to the electron gun assembly and the cathode ray tube of this embodiment, as described above, the electrodes can be formed with priority to the required properties of the cathode ray tube, including the physical and mechanical properties, by superposing a high-moldability metallic material on at least those regions around the electron beam holes which require complicated molding, even though the metallic material is originally poor in press-moldability for the electrodes. Thus, the press-moldability can be improved without failing to fulfill the various properties for the electrodes.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electron gun assembly comprising:
a cathode capable of emitting electron beams; and
at least first and second grid electrodes having electron beam holes through which the electron beams emitted from the cathode are passed individually and capable of controlling the electron beams,
the first and/or second grid electrode being a superposed structure formed of different metallic materials superposed in the advancing direction of the electron beams and including a Fe—Ni—Co alloy located around the electron beam holes.

2. An electron gun assembly according to claim 1, wherein said Fe—Ni—Co alloy is located in a region around each electron beam hole 15 to 650 times as wide as the area of each electron beam hole, and has a thickness equal to 40% or more of the overall thickness of the superposed structure.

3. A cathode ray tube comprising:
a substantially rectangular face panel;
a funnel connected to the face panel;
an electron gun assembly located in a neck of the funnel and having a plurality of grid electrodes capable of controlling electron beams; and
a phosphor screen formed on the inner surface of the face panel,
a first and/or second grid electrode, among other grid electrodes of the electron gun assembly, being a superposed structure formed of different metallic materials superposed in the advancing direction of the electron beams and including a Fe—Ni—Co alloy located around the electron beam holes.

4. A cathode ray tube according to claim 3, wherein said Fe—Ni—Co alloy is located in a region around each electron beam hole 15 to 650 times as wide as the area of each electron beam hole, and has a thickness equal to 40% or more of the overall thickness of the superposed structure.
